(19) United States
(12) Patent Application Publication
(10) Pub. No.: US 2013/0257728 A1
(43) Pub. Date: Oct. 3, 2013

(54) MULTIPLEXED AUDIO CABLE JOYSTICK AND SYSTEM THEREOF

(71) Applicants: Kung-Wang LEE, Hsinchu County (TW); Chih-Chang CHIEN, Hsinchu County (TW); Cheng-Chiang LIU, Hsinchu County (TW); Chia-Sheng HSU, Hsinchu City (TW); Chih-Hsiang YANG, Hsinchu City (TW)

(72) Inventors: Kung-Wang LEE, Hsinchu County (TW); Chih-Chang CHIEN, Hsinchu County (TW); Cheng-Chiang LIU, Hsinchu County (TW); Chia-Sheng HSU, Hsinchu City (TW); Chih-Hsiang YANG, Hsinchu City (TW)

(21) Appl. No.: 13/586,907

(22) Filed: Aug. 16, 2012

(30) Foreign Application Priority Data
Mar. 30, 2012 (TW) 101111317

(51) Int. Cl. G06F 3/033

(52) U.S. Cl. 345/161

(57) ABSTRACT

A multiplexed audio cable joystick includes plural keys, a key scanner, a frame format encoder, a transmission modulator, and a DAC. The key scanner is connected to the keys for scanning states of the keys to output pressed key information, The frame format encoder is connected to the key scanner for generating a frame transmission data according to the pressed key information. The transmission modulator is connected to the frame format encoder for performing a carrier modulation on the frame transmission data to generate a modulated transmission data. The DAC is connected to the transmission modulator for converting the modulated transmission data into an analog audio data. The transmission modulator has the same frequency band as an audio signal spectrum, and the frequency band has plural sub-bands, such that the transmission modulator modulates the frame transmission data into one of the sub-bands for transmitting data in multiplexing.

### CROSS REFERENCE TO RELATED APPLICATION

This application claims the benefits of the Taiwan Patent Application Ser. No. 101111317. filed on Mar. 30, 2012, the subject matter of which is incorporated herein by reference.

### BACKGROUND OF THE INVENTION

1. Field of the Invention

The present invention relates to the technical field of data transmission and, more particularly, to a multiplexed audio cable joystick and system thereof.

2. Description of Related Art

Current consumer electronics are typically provided with a touchpad as one of the input devices. To meet with the requirements of being light, thin, short, and small, a touchpad and a panel are combined into a touch panel for a user to conveniently input data,

However, the touchpad may not be suitable for an input on a consumer electronic product, particularly for a rapid and accurate input. Therefore, when currently marketing iOS devices, such as iPad, iPhone available from Apple, are used by a user to play video games, an external joystick is typically added.

FIG. 1 is a view of a typical add-on joystick 100 with two transparent and flexible sucking discs 110, 120 made of resin. FIG. 2 is a schematic view of the joystick 100 of FIG. 1 in use. For playing the video games, the joystick 100 is attached onto the screen 210 of an iPad device 200 via the sucking discs 110, 120. However, the joystick 100 may be easily departed from the screen 210 due to the sucking discs 110, 120, resulting in blocking the sight of a user.

FIG. 3 is a schematic view of a typical joystick base 320 in use. When an iPhone device 310 and a joystick base 320 are jointed, the user can use the joystick base 320 to play the video games, which can avoid the problems of the departed sucking discs 110, 120 and blocked sight in FIG. 2. However, the joystick base 320 generally has a volume bigger than the iPhone device 310 and cannot be carried easily. In addition, the royalty is high so as to result in a high marketing price.

Another solution is to use a wireless joystick, such as a Bluetooth joystick. However, a Bluetooth chip is expensive and requires the initialization before being used, i.e., without the plug and play function, which is inconvenient in use.

As the smart phones and tablet computers become more and more popular, it is urgently necessary to have a joystick to connect with them. Therefore, it is desirable to provide an improved multiplexed audio cable joystick and system thereof to mitigate and/or obviate the aforementioned problems.

SUMMARY OF THE INVENTION

The object of the present invention is to provide a multiplexed audio cable joystick and system thereof, in which an audio cable is used to transmit pressed key information, so as to obtain the joystick at low cost and practice.

According to a feature of the invention, a multiplexed audio cable joystick is provided, which includes a plurality of keys, a key scanner, a frame format encoder, a transmission modulator, and a digital to analog converter (DAC), The key scanner is connected to the keys in order to scan a state of the keys to be pressed to thereby output corresponding pressed key information. The frame format encoder is connected to the key scanner in order to generate a frame transmission data according to the pressed key information, The transmission modulator is connected to the frame format encoder in order to perform a carrier modulation on the frame transmission data o thereby generate a modulated transmission data. The DAC is connected to the transmission modulator in order to convert the modulated transmission data into an analog audio data, wherein the transmission modulator has a same frequency band as an audio signal spectrum, and the frequency band has a plurality of sub-bands, such that the transmission modulator modulates the frame transmission data to one of the sub-bands for transmitting data multiplexing.

According to another feature of the invention, a multiplexed audio cable joystick system is provided, which includes a first multiplexed audio cable joystick, a second multiplexed audio cable joystick, a Y-type audio connection line, and a portable electronic device. The first multiplexed audio cable joystick has a plurality of first keys in order to modulate pressed key information of the first keys to a first sub-band of an audio signal spectrum for converting into a first analog signal. The second multiplexed audio cable joystick has a plurality of second keys in order to modulate pressed key information of the second keys to a second sub-band of the audio signal spectrum for being converted into a second analog signal. The Y-type audio connection line is connected to the first multiplexed audio cable joystick and the second multiplexed audio cable joystick in order to mix the first analog signal and the second analog signal to thereby generate an analog mixing signal, wherein the analog mixing signal has the first and second analog signals. The portable electronic device has a headphone jack connected to the Y-type audio connection line in order to receive and decode the first analog signal and the second analog signal to thereby generate the first pressed key information of the first multiplexed audio cable joystick and the second pressed key information of the second multiplexed audio cable joystick.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a prior add-on joystick;

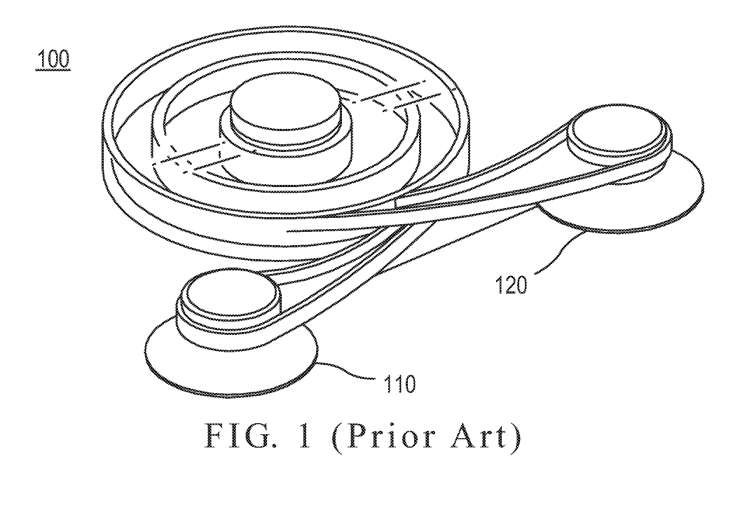

FIG. 2 is a schematic view of a prior add-on joystick in use;

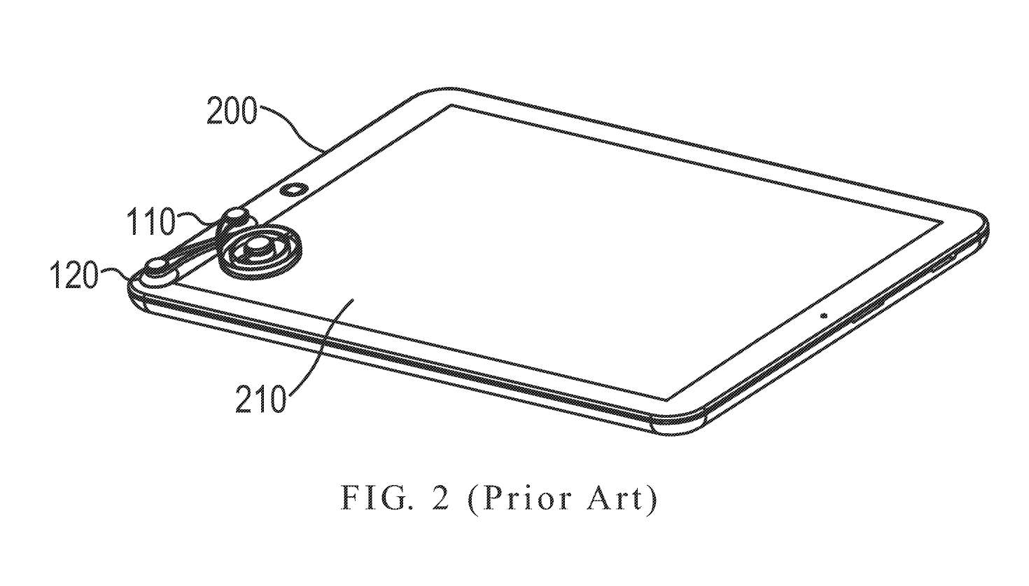

FIG. 3 is a schematic view of a prior joystick base in use;

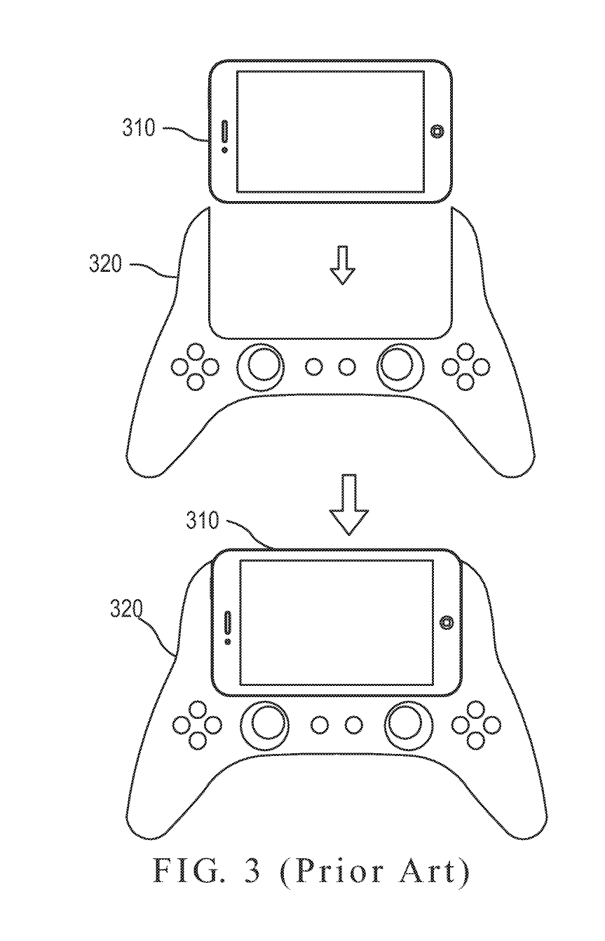

FIG. 4 is a block diagram of a multiplexed audio cable joystick according to an embodiment of the invention;

FIG. 5 is a schematic diagram of a frame transmission data according to an embodiment of the invention;

FIG. 6 is a schematic view of a multiplexed audio cable joystick system according to an embodiment of the invention; and

FIG. 7 is a block diagram of a portable electronic device according to an embodiment of the invention.

### DETAILED DESCRIPTION OF THE PREFERRED EMBODIMENT

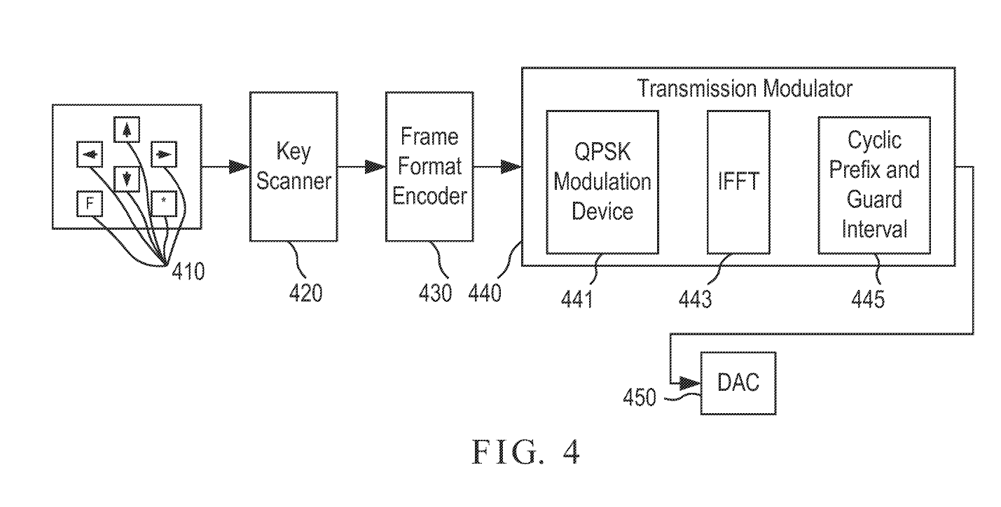

FIG. 4 is a block diagram of a multiplexed audio cable joystick 400 according to an embodiment of the invention. The joystick 400 includes a plurality of keys 410, a key scanner 420, a frame format encoder 430, a transmission modulator 440, and a digital to analog converter (DAC) 450.

The keys 410 are used as an input of the joystick 400, and have several directional keys, a firing key, and a continuous firing key.

The key scanner 420 is connected to the keys 410 in order to scan a state of the keys 410 to be pressed to thereby output corresponding pressed key information. The pressed key information can be represented by 16 bits, each corresponding to a key for indicating whether the key is pressed or not.

For example, the four directional keys of FIG. 4 correspond to bit 0 to bit 3 of the pressed key information. When bit 0=1, it indicates that the corresponding key is pressed.

The frame format encoder 430 is connected to the key scanner 420 in order to generate a frame transmission data according to the pressed key information.

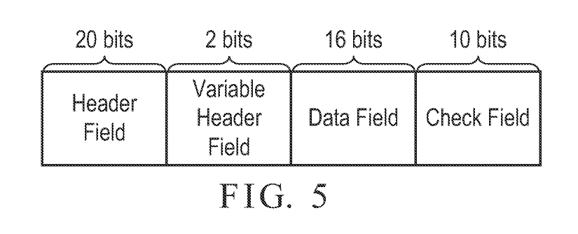

FIG. 5 is a schematic diagram of a frame transmission data according to an embodiment of the invention. The frame transmission data has 48 bits, and includes a header field, a variable header field, a data field, and a check field.

The header field has, for example, 20 bits to store an identifier of a special pattern to help the decoder with a simple recognition and further a synchronous decoding.

The variable header field has, for example, 2 bits to recognize a joystick 400 when more than one joysticks are existed, wherein “00” indicates the first joystick, “01” indicates the second joystick, and so

The data field has, for example, 16 bits to record the 16-bit pressed key information.

The check field has, for example, 10 bits to check whether the data is correct or not. The content of the check field is generated by performing a cyclic redundancy check (CRC) process on the variable header field and the data field.

The transmission modulator 440 is connected to the frame format encoder 430 in order to perform a carrier modulation on the frame transmission data to thereby generate a modulated transmission data.

The transmission modulator 440 has the same frequency band as the audio signal spectrum. The frequency band has a plurality of sub-bands, such that the transmission modulator modulates the frame transmission data into one of the sub-bands for transmitting data in multiplexing.

The transmission modulator 440 includes a quadrature phase shift keying (QPSK) modulation device 441, an inverse fast Fourier transform (IFFT) device 443, and a cyclic prefix and guard interval device 445.

The QPSK modulation device 441 is connected to the frame format encoder 430 in order to perform a quadrature phase shift keying on the frame transmission data to thereby output multiple phases (i.e., generating a multi-phase output). Since the frame transmission data is of 48 bits, the QPSK modulation device 441 can output 24 phases after the quadrature phase shift keying is performed on the frame transmission data.

The IFFT device 443 is connected to the QPSK modulation device 441 in order to perform an inverse fast Fourier transform on the phases to thereby generate a multi-carrier modulation signal.

The IFFT device 443 is a 128-dot IFFT device to carry out the multi-carrier modulation, and in this case a 128-dot multi-carrier modulation signal is generated after the inverse fast Fourier transform is performed on the phases. Further, each joystick 400 is set to a different sub-band that is used by its corresponding IFFT device. For example, in this embodiment, the 128-dot IFFT device is used to perform the multi-carrier modulation, where the 6-29 carriers are of the first sub-band (corresponding to the first joystick 400), and the 33-56 carriers are of the second sub-band (corresponding to the second joystick 400).

When more joysticks 440 are used, the carrier sub-bands can be reallocated to the joysticks respectively, or a 256-dot IFFT device is used to increase the number of carriers. This can be accomplished by those skilled in the art, and thus a detailed description is deemed unnecessary.

The cyclic prefix and guard interval device 445 is connected to the IFFT device 443 in order to add a cyclic prefix as a guard interval in the multi-carrier modulation signal to thereby generate the modulated transmission data. In this case, the cyclic prefix and guard interval device 445 adds a 72-dot guard interval in the 128-dot multi-carrier modulation signal to thereby generate a 200-dot modulated transmission data.

The DAC 450 is connected to the transmission modulator 440 in order to convert the modulated transmission data into an analog audio data. The IFFT device 443 of each joystick 400 uses a different sub-band to perform the multi-carrier modulation, such that the transmission modulator of the joystick can modulate the frame transmission data to the different sEib-band to thereby obtain a frequency division multiplexing (FDM) communication transmission. Further, the DAC 450 has a sampling rate of 16 KHz, i.e., the 200-dot modulated transmission data. The DAC 450 with the 1.6 KHz sampling rate outputs the audio signal to thereby obtain that the key data transmission time of the joystick 400 is 0.0125 sec. (200/16 KHz), i.e., the key update frequency thereof is 80 Hz (16 KHz/200). Such an 80 Hz key update frequency is higher than the fresh frequency (60 Hz) of a typical liquid crystal screen, so it can be used in a portable device with a liquid crystal screen, and the speed can meet with the user requirement.

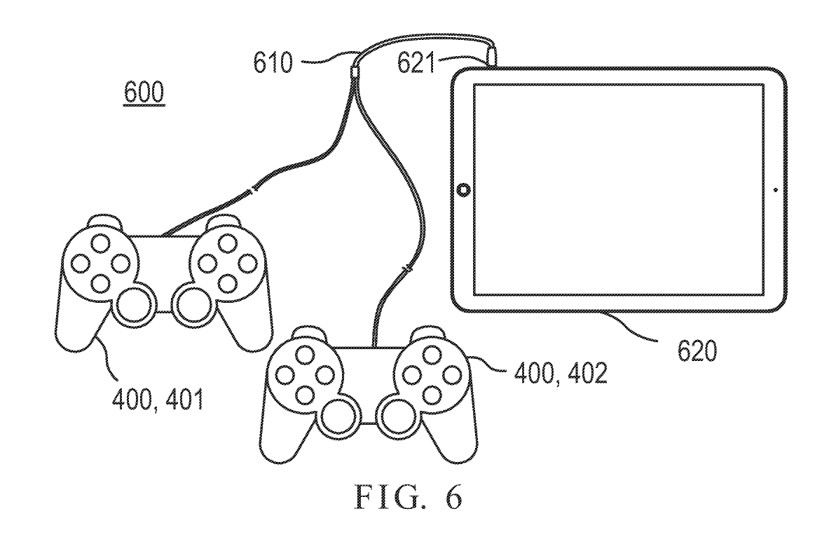

FIG. 6 is a schematic view of a multiplexed audio cable joystick system 600 according to an embodiment of the invention. The system 600 includes a first multiplexed audio cable joystick 401, a second multiplexed audio cable joystick 402, a Y-type audio connection line 610, and a portable electronic device 620.

The first multiplexed audio cable joystick 401 has a plurality of first keys 410 in order to modulate pressed key information of the first keys to a first sub-band of an audio signal spectrum for being converted into a first analog signal of the first sub-band, wherein the first sub-band is in a relatively low frequency band of the audio signal spectrum.

The second multiplexed audio cable joystick 402 has a plurality of second keys 410 in order to modulate the pressed key information of the second keys to a second sub-band of the audio signal spectrum for being converted to a second analog signal of the second sub-band, wherein the second sub-band is in a relatively high frequency band of the audio signal spectrum.

The Y-type audio connection line 610 is connected to the first multiplexed audio cable joystick 401 and the second multiplexed audio cable joystick 402 in order to mix the first analog signal and the second analog signal to thereby generate an analog mixing signal for output. Namely, the Y-type audio connection line 610 outputs the analog mixing signal which contains the first and second analog signals in mixing.

The portable electronic device 620 has a headphone jack 621 connected to the Y-type audio connection line in order to receive and decode the first analog signal and the second analog signal to thereby generate the first pressed key information of the first multiplexed. audio cable joystick and the second pressed key information of the second multiplexed audio cable joystick.

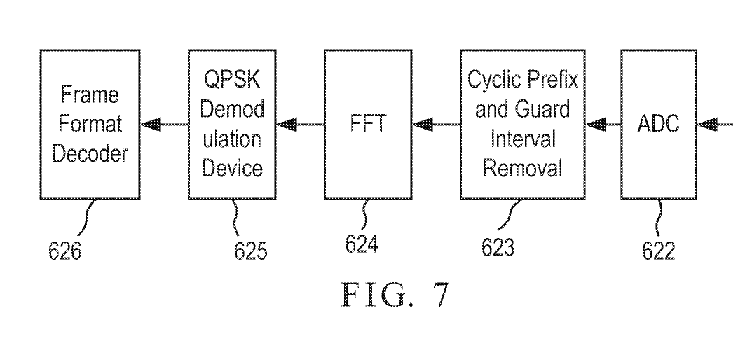

FIG. 7 is a block diagram of the portable electronic device 620 according to an embodiment of the invention. The portable electronic device 620 inch des an analog to digital converter (ADC) 622, a cyclic prefix and guard interval removal device 623, a fast Fourier transform (FFT) device 624, a QPSK demodulation device 625, and a frame format decoder 626. In order to save the cost, the cyclic prefix and guard interval removal device 623, the FFT 624, the QPSK demodulation 625, and the frame format decoder 626 can be implemented with software.

The ADC 622 is connected to the headphone jack 621 in order to receive the analog mixing signal for being converted into a digital mixing signal.

The ADC 622 uses a sampling rate of 16 KHz. Namely, the ADC 622 can sample the audio signal at the input end of the headphone jack 621 in real time.

The cyclic prefix and guard interval removal device 623 is connected to the ADC 622 in order to remove the 72-dot guard interval signal, which is possibly polluted by an inter-symbol interference, so as to output the pure 128-dot digital mixing signal which the guard interval is removed.

The EFT device 624 is connected to the cyclic prefix and guard interval removal device 623 in order to perform fast Fourier transform on the pure 128-dot digital mixing signal to thereby generate the phase and amplitude of a 128-dot FFT modulation signal.

The QPSK demodulation device 625 is connected to the FFT device 624 in order to perform a QPSK demodulation on the phase and amplitude of the 128-dot FFT modulation signal to thereby generate a first frame transmission data corresponding to the first sub-band and a second first frame transmission data corresponding to the second sub-band.

The frame format decoder 626 is connected to the QPSK demodulation device 625 in order to perform a frame format decoding on the first and the second frame transmission data to thereby generate the first pressed key information corresponding to the first multiplexed audio cable joystick and the second pressed key information corresponding to the second multiplexed audio cable joystick.

As cited, the portable electronic device 620 can receive the pressed key information respectively sent by the first and the second multiplexed audio cable joysticks 401 and 402.

The invention can use the headphone jack of an iOS device (iPhone, iPad, iPod Touch, or the like) as a transmission interface to replace a USB, UART, Bluetooth, touch panel or the like as the input interface of a joystick.

With an increase of the number of joysticks, a higher PSK (such as 8 PSK: octal phase shift keying or 16 PSK: hexadecimal phase shift keying) and a multi-carrier modulation with more carriers can be used to carry more bit message in an analog audio signal and to transmit the key state to the iOS device through an audio cable in real time.

When the number of keys of the joystick is largely increased and the key arrangement is changed, the invention can change the joystick into a keyboard. Namely, the invention can simply develop the joystick as the input keyboard of the iOS device through an audio cable.

As cited, the iOS device uses a touch panel for interaction in the prior art, which may suffer an inconvenient operation in using the touch panel. In this case, the invention uses the audio cable in transmission to thus obtain the low-cost and practical joystick, so as to overcome the currently marketing problems.

Although the present invention has been explained in relation to its preferred embodiment, it is to be understood that many other possible modifications and variations can be made without departing from the spirit and scope of the invention as hereinafter claimed.

What is claimed is:

1. A multiplexed audio cable joystick, comprising:
a plurality of keys;
a key scanner connected to the keys for scanning states of the keys so as to output corresponding pressed key information;
a frame format encoder connected to the key scanner for generating a frame transmission data according to the pressed key information;
a transmission modulator connected to the frame format encoder for performing a carrier modulation on the frame transmission data so as to generate a modulated transmission data; and
a digital to analog converter connected to the transmission modulator for converting the modulated transmission data into an analog audio data,
wherein the transmission modulator has a same frequency band as an audio signal spectrum, and the frequency band has a plurality of sub-bands, such that the transmission modulator modulates the frame transmission data into one of the sub-bands for transmitting data in multiplexing.

2. The multiplexed audio cable joystick as claimed in claim 1, wherein the transmission modulator comprises:
a quadrature phase shift keying modulation device connected to the frame format encoder for performing a quadrature phase shift keying on the frame transmission data so as to output multiple phases;
an inverse fast Fourier transform device connected to the quadrature phase shift keying modulation device or performing an inverse fast Fourier transform on the phases so as to generate a multi-carrier modulation signal; and
a cyclic prefix and guard interval device connected to the inverse fast Fourier transform device for adding a cyclic prefix as a guard interval in the multi-carrier modulation signal so as to generate the modulated transmission data.

3. The multiplexed audio cable joystick as claimed in claim 2, wherein the pressed key information is represented in 16 bits, and each bit corresponds to a key for indicating whether the key is pressed or not.

4. The multiplexed audio cable joystick as claimed in claim 1, wherein the frame transmission data comprises a header field, a variable header field, a data field, and a check field.

5. The multiplexed audio cable joystick as claimed in claim 4, wherein the header field has 20 bits, the variable header field has 2 bits, the data field has 16 bits, and the check field has 10 bits.

6. The multiplexed audio cable joystick as claimed in claim 5, wherein a content of the check field is generated by performing a cyclic redundancy check process on the variable header field and the data field.

7. The multiplexed audio cable joystick as claimed in claim 6, wherein the frame transmission data is represented in 48 bits, such that the quadrature phase shift keying modulation device performs a quadrature phase shift keying modulation on the frame transmission data to generate 24 phases.

8. The multiplexed audio cable joystick as claimed in claim 7, wherein the inverse fast Fourier transform device is a 128-dot inverse fast Fourier transform device connected to the quadrature phase shift keying modulation device, such that an inverse fast Fourier transform is performed on the 24 phases to generate a 128-dot multi-carrier modulation signal.

9. The multiplexed audio cable joystick as claimed in claim 8, wherein the cyclic prefix and guard interval device adds a 72-dot guard interval signal in the 128-dot multi-carrier modulation signal to generate a 200-dot modulated transmission data.

10. The multiplexed audio cable joystick as claimed in claim 1, wherein the digital to analog converter has a sampling rate of 16 KHz.

11. A multiplexed audio cable joystick system, comprising:
a first multiplexed audio cable joystick having a plurality of first keys for modulating first pressed key information of the first keys into a first sub-band of audio signal spectrum for being converted into a first analog signal;
a second multiplexed audio cable joystick having a plurality of second keys for modulating second pressed key information of the second keys into a second sub-band of audio signal spectrum for being converted into a second analog signal;
a Y-type audio connection line connected to the first multiplexed audio cable joystick and the second multiplexed audio cable joystick for performing an analog audio mixing to generate an analog mixing signal, wherein the analog mixing signal has the first and second analog signals; and
a portable electronic device having a headphone jack connected to the Y-type audio connection line for receiving and decoding the first analog signal and the second analog signal to generate the first pressed key information of the first multiplexed audio cable joystick and the second pressed key information of the second multiplexed audio cable joystick.

12. The multiplexed audio cable joystick system as claimed in claim 11, wherein the portable electronic device comprises:
an analog to digital converter connected to the headphone jack for receiving the analog nixing signal to be converted into a digital mixing signal;
a cyclic prefix and guard interval removal device connected to the analog to digital converter for removing a 72-dot guard interval signal to output a 128-dot digital mixing signal in which the guard interval signal is removed;
a fast Fourier transform (FFT) device connected to the cyclic prefix and guard interval removal device for performing a fast Fourier transform on the 128-dot digital mixing signal to generate a phase and amplitude of a 128-dot FFT modulation signal;
a quadrature phase shift keying demodulation device connected to the FFT device for performing a quadrature phase shift keying demodulation on the phase and amplitude of the 128-dot FFT modulation signal to generate a first frame transmission data corresponding to the first sub-band and a second first frame transmission data corresponding to the second sub-band; and
a frame format decoder connected to the quadrature phase shift keying demodulation device for performing a frame format decoding on the first and the second frame transmission data to generate the first pressed key information corresponding to the first multiplexed audio cable joystick and the second pressed key information corresponding to the second multiplexed audio cable joystick.

13. The multiplexed audio cable joystick system as claimed in claim 12, wherein the first sub-band is in a relatively low frequency band of the audio signal spectrum, and the second sub-band is in a relatively high frequency band of the audio signal spectrum.

14. The multiplexed audio cable joystick system as claimed in claim 11, wherein each of the first and the second multiplexed audio cable joysticks comprises:
a plurality of keys;
a key scanner connected to the keys for scanning states of the keys to be pressed so as to output corresponding pressed key information
a frame format encoder connected to the key scanner for generating a frame transmission data according to the pressed key information;
a transmission modulator connected to the frame format encoder for performing a earner modulation on the frame transmission data so as to generate a modulated transmission data; and
a digital to analog converter connected to the transmission modulator for converting the modulated transmission data into an analog audio data,
wherein the transmission modulator has a same frequency band as an audio signal spectrum, and the frequency band has a plurality of sub-bands, such that the transmission modulator modulates the frame transmission data into one of the sub-bands for transmitting data in multiplexing.

15. The multiplexed audio cable joystick system as claimed in claim 14, wherein the transmission modulator comprises:
a quadrature phase shift keying modulation device connected to the frame format encoder for performing a quadrature phase shift keying on the frame transmission data to output multiple phases;
an inverse fast Fourier transform device connected to the quadrature phase shift keying modulation device for performing an inverse fast Fourier transform on the phases to generate a multi-carrier modulation signal; and
a cyclic prefix and guard interval device connected to the inverse fast Fourier transform device for adding a cyclic prefix as a guard interval in the multi-carrier modulation signal to generate the modulated transmission data.

16. The multiplexed audio cable joystick system as claimed in claim 15, wherein the pressed key information is represented in 16 bits, and each bit corresponds to a key for indicating whether the key is pressed or not.

17. The multiplexed audio cable joystick system as claimed in claim 14, wherein the frame transmission data comprises a header field with 20 bits, a variable header field with 2 bits, a data field with 16 bits, and a check field with 10 bits, and a content of the check field is generated by performing a cyclic redundancy check process on the variable header field and the data field.

18. The multiplexed audio cable joystick system as claimed in claim 14, wherein the frame transmission data is represented in 48 bits, such that the quadrature phase shift keying modulation device performs a quadrature phase shift keying modulation on the frame transmission. data to generate 24 phases.

19. The multiplexed audio cable joystick system as claimed in claim 15, wherein the inverse fast Fourier transform device is a 128-dot inverse fast Fourier transform device connected to the quadrature phase shift keying modulation device, such that an inverse fast Fourier transform is performed on the 24 phases to generate a 128-dot multi-carrier modulation signal and the cyclic prefix and guard interval device adds a 72-dot guard interval signal in the 128-dot multi-carrier modulation signal to generate a 200-dot modulated transmission data.

20. The multiplexed audio cable joystick system as claimed in claim 14, wherein the digital to analog converter has a sampling rate of 16 KHz.
